(19) United States
(12) Patent Application Publication
(10) Pub. No.: US 2011/0068893 A1
(43) Pub. Date: Mar. 24, 2011

(54) RFID FINGERPRINT CREATION AND UTILIZATION

(75) Inventor: Sandip Lahiri, Tampa, FL (US)

(73) Assignee: INTERNATIONAL BUSINESS MACHINES CORPORATION, Armonk, NY (US)

(21) Appl. No.: 12/564,301

(22) Filed: Sep. 22, 2009

(51) Int. Cl. G06F 7/04; G06K 7/01

(52) U.S. Cl. 340/5.8; 340/10.1; 340/10.42

(57) ABSTRACT

Embodiments of the present invention provide a method, system and computer program product for creating and managing radio frequency identification (RFID) fingerprints to ensure item authenticity. In an embodiment of the invention, an object fingerprint creation method can be provided. The method can include receiving a sensed signal from at least one RFID reader resulting from at least one RFID tag affixed to a target object. The method further can include extracting a voltage produced by the RFID tag from the sensed signal. Finally, the method can include storing the voltage as a fingerprint for the target object for later comparison with another fingerprint for an authenticating object to determine whether or not the authenticating object is the target object.

### BACKGROUND OF THE INVENTION

1. Field of the Invention

The present invention relates to the field of Radio Frequency Identification (RFID) and more particularly to verifying item authenticity through ePedigree.

2. Description of the Related Art

RFID is an area of automatic identification that has quietly been gaining momentum in recent years and is now being seen as a radical means of enhancing data handling processes, complimentary in many ways to other data capture technologies such bar coding. The object of any RFID system is to carry data in suitable transponders, generally known as tags, and to retrieve data, by machine readable means, at a suitable time and place to satisfy particular application needs. Data within a tag may provide identification for an item in manufacture, goods in transit, a location of an item, the identity of a vehicle, an animal or an individual. By including additional data the prospect is provided for supporting applications through item specific information or instructions immediately available on reading the tag.

An RFID object tracking system requires, in addition to tags, a means of reading or interrogating the tags and some means of communicating the data to a host computer or information management system. In this respect, an RFID object tracking system also can include a facility for programming data into the tags. Notably, the tags can be active and powered in nature, or passive and unpowered in nature. Communication of data between tags and a reader can be by wireless communication. Two methods distinguish and categorize RFID object tracking systems, one based upon close proximity electromagnetic or inductive coupling and one based upon propagating electromagnetic waves. Coupling is via ‘antenna’ structures forming an integral feature in both tags and readers. While the term antenna is generally considered more appropriate for propagating systems it is also loosely applied to inductive systems.

RFID systems can be roughly grouped into four categories: electronic article surveillance (EAS) systems, portable data capture systems, networked systems and positioning systems. EAS systems typically involve a one bit system used to sense the presence or absence of an item. Portable data capture systems, by comparison, can be characterized by the use of portable data terminals with integral RFID readers and can be used in applications where a high degree of variability in sourcing required data from tagged items may be exhibited. Networked system applications can generally be characterized by fixed position readers deployed within a given site and connected directly to a networked information management system. The transponders are positioned on moving or moveable items, or people, depending upon application. Finally, positioning systems use transponders to facilitate automated location and navigation support for guided vehicles.

Despite the ability to track an item or identify an item readily according to RFID, the authenticity of an item remains at issue. To truly ensure the authenticity of an item from creation/manufacture to ultimate possessor, a chain of custody must be established and guaranteed so that the ultimate possessor can rest assured that the item possessed is the same item as was earlier created. The problem of item authenticity has become of paramount concern particularly within the pharmaceutical industry in which it must be guaranteed that the same drug consumed by a consumer is the same drug manufactured as labeled by the manufacturer. The electronic pedigree, otherwise known as the “ePedigree” has resulted directly from the concerns of the pharmaceutical industry with respect to the authenticity of a tracked item.

An ePedigree is simply an electronic document which satisfies a pedigree requirement. The primary purpose of an epedigree is to protect consumers from contaminated medicine or counterfeit drugs. Recently, the Pedigree Standard has been ratified as an international standard that specifies an extensible markup language (XML) description of the life history of a product across an arbitrarily complex supply chain. Notwithstanding, while simple ePedigree systems are important as an initial attempt at securing the authenticity of a tracked item in a supply chain, simple ePedigree systems are not suitable for ensuring the authenticity of many different types of items—particularly items easily counterfeited or items that frequently change hands over a long period of time, such as different works of art, antique furniture and the like.

### BRIEF SUMMARY OF THE INVENTION

Embodiments of the present invention address deficiencies of the art in respect to the ePedigree system and provide a novel and non-obvious method, system and computer program product for creating and managing RFID fingerprints to ensure item authenticity. In an embodiment of the invention, an object fingerprint creation method can be provided. The method can include receiving a sensed signal from at least one RFID reader resulting from at least one RFID tag affixed to a target object. The method further can include extracting a voltage produced by the RFID tag from the sensed signal. Finally, the method can include storing the voltage as a fingerprint for the target object for later comparison with another fingerprint for an authenticating object to determine whether or not the authenticating object is the target object.

In one aspect of the embodiment, storing the voltage as a fingerprint for the target object can include additionally extracting a unique identifier produced by the RFID tag from the sensed signal and associating the unique identifier with the voltage. Further, the unique identifier and voltage can be encoded into a value. Finally, the value can be stored as the fingerprint for the target object. Optionally, the fingerprint can be encrypted prior to storing the fingerprint. Thereafter, a current fingerprint can be generated for an authenticating object such that the current fingerprint includes at least one voltage extracted from a sensed signal from an RFID reader for a corresponding RFID tag affixed to the authenticating object. Subsequently, the current fingerprint can be compared to the stored fingerprint and it can be computed whether the compared current fingerprint and stored fingerprint differ by less than a threshold value. Finally, the authenticating object can be determined to be authentic responsive to the current fingerprint and stored fingerprint differing by less than the threshold value, but otherwise the authenticating object can be determined to be unauthentic.

In another embodiment of the invention, an object authenticating data processing system can be provided. The system can include a host computer including a processor, memory, and an operating system executing therein. The system also can include an RFID data acquisition application hosted by the operating system and coupled to different RFID readers positioned to define a sensing zone. A data store of stored fingerprints can be coupled to the host computer, each stored fingerprint corresponding to a different target object. Finally, a fingerprint module can be coupled to the RFID data acquisition application and configured for execution in the memory of the host computer by the processor of the host computer. The module can include computer program instructions which when executed by the processor receive a sensed signal from the RFID data acquisition application for the RFID readers resulting from a plurality of RFID tags affixed to an authenticating object disposed in the sensing zone, extract a voltage produced by each of the RFID tags from the sensed signal, arrange each extracted voltage into a current fingerprint, and compare the current fingerprint with another fingerprint for an already processed object to determine whether or not the authenticating object is the already processed object.

In one aspect of the embodiment, the RFID tags are positioned at different angles on at least one surface of the authenticating object. In another aspect of the embodiment, the stored fingerprints are encrypted. In yet another aspect of the embodiment, the stored fingerprints include a set of values, each value comprising a unique identifier of an RFID tag, a modulated direct current voltage of the RFID tag corresponding to the unique identifier and a maximum fluctuation of the direct current voltage for the RFID tag corresponding to the unique identifier.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for creating and managing RFID fingerprints to ensure item authenticity;

FIG. 2 is a schematic illustration of an RFID data processing system configured for creating and managing RFID fingerprints to ensure item authenticity; and,

FIG. 3 is a flow chart illustrating a process for managing RFID fingerprints to ensure item authenticity.

### DETAILED DESCRIPTION OF THE INVENTION

Embodiments of the present invention provide a method, system and computer program product for creating and managing RFID fingerprints to ensure object authenticity. In accordance with an embodiment of the present invention, a fingerprint can be acquired from a target object with at least one RFID tag affixed thereto. Specifically, the fingerprint can include a signal reading of the RFID tag resulting from a particular orientation of the target object in a sensing zone approximate to one or more RFID readers. The signal can be converted to a value by way of an encoding process and, optionally encrypted before storage as a fingerprint for the target object. Thereafter, if the object is to be authenticated to ensure proper pedigree, the same object can be analyzed at a same or similar orientation in the sensing zone approximate to the RFID reader or readers positioned the same or similar as before. Again, the resulting signal can be encoded to a value and compared to an unencrypted form of the stored fingerprint. If the encoded values match within an acceptable range of error, the object to be authenticated can be assumed to be the same object as the target object.

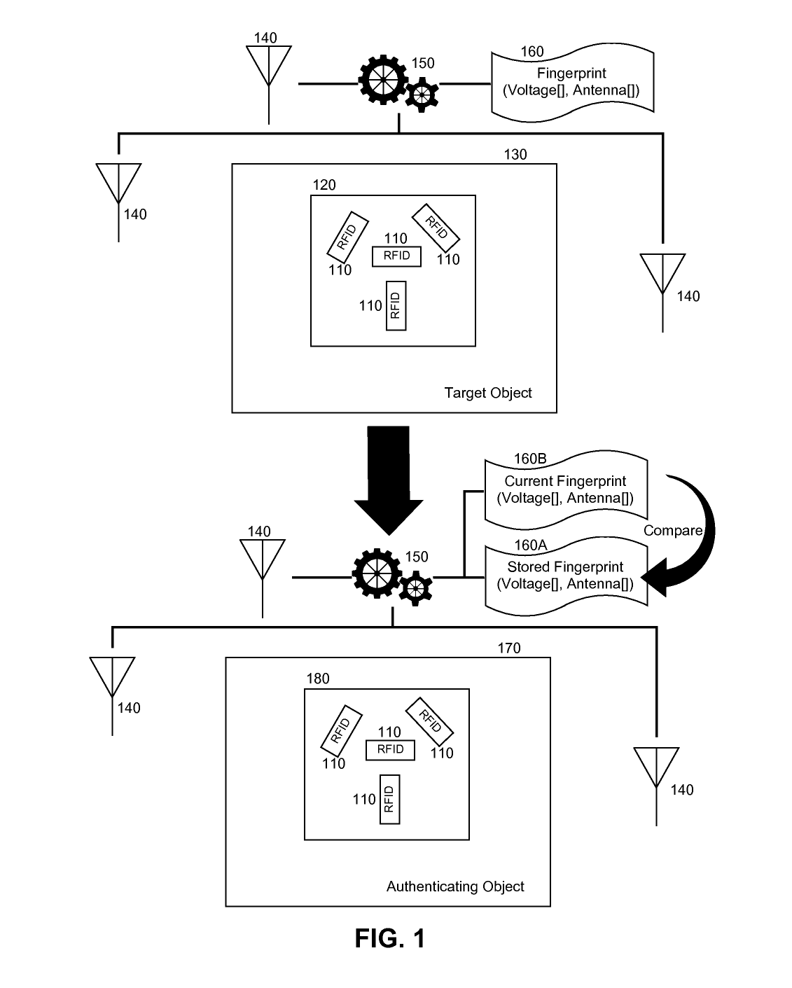

In further illustration, FIG. 1 pictorially shows a process for creating and managing RFID fingerprints to ensure object authenticity. As shown in FIG. 1, one or more RFID tags 110 can be applied in a selected arrangement to a target object 120. The target object 120 can be placed in a sensing zone 130 proximate to one or more RFID sensors 140. The RFID sensors 140 can be positioned about the sensing zone 130, for example perpendicularly to a plane defined by a face of the target object 120 to which the RFID tags 110 have been affixed. To the extent that the target object 120 is not a relatively thin and flat object, but an object of depth and height and width, the RFID sensors 110 can be affixed on one or more faces about the target object 120 and the RFID sensors 140 can be positioned perpendicularly to at least one of the faces of the target object 120.

A fingerprint creation processor 150 can read the sensed signal from each of the RFID sensors 140 with respect to the RFID tags 110 of the target object 120 in the sensing zone 130, and can extract from the sensed signal a voltage level for each of the RFID tags 110, and an identification of each of the RFID tags 110 corresponding to each extracted voltage level. The data extracted from the sensed signal can be subjected to an encoding process to produce a value or set of values. The encoding process can be any algorithmic process that accepts as input the extracted data to produce as an output, one or more values. Optionally, the values produced by the encoding process can be encrypted. The resulting values, optionally encrypted, can be stored in association with the target object 120 as a fingerprint for the target object 120.

Subsequently, an authenticating object 180 can be authenticated by producing a current fingerprint 160B for comparison with a stored fingerprint 160A associated with an object purported to be the authenticating object 180. Specifically, the authenticating object 180 can be placed in a sensing zone 170 proximate to RFID sensors 140 positioned in the same manner as at the time the stored fingerprint 160A had been generated for object purported to be the authenticating object 170. A sensed signal can be acquired from the RFID tags 110 of the authenticating object 180 and voltage level for each of the RFID tags 110 can be extracted from the sensed signal in association with an identity for each of the RFID tags 110 affixed to the authenticating object 180.

The data extracted from the sensed signal can be subjected to the same encoding process as before to produce a value or set of values in a current fingerprint 160B. Thereafter, the value or set of values in the fingerprint 160B produced for the authenticating object 180 can be compared to a decrypted form of the value or set of values in the stored fingerprint 160A. To the extent that the fingerprints 160A, 160B compare favorably either as a match, or within a determined tolerance for margin of error, the authenticating object 180 can be determined to be authentic. Otherwise, the authenticating object 180 can be determined not to be authentic.

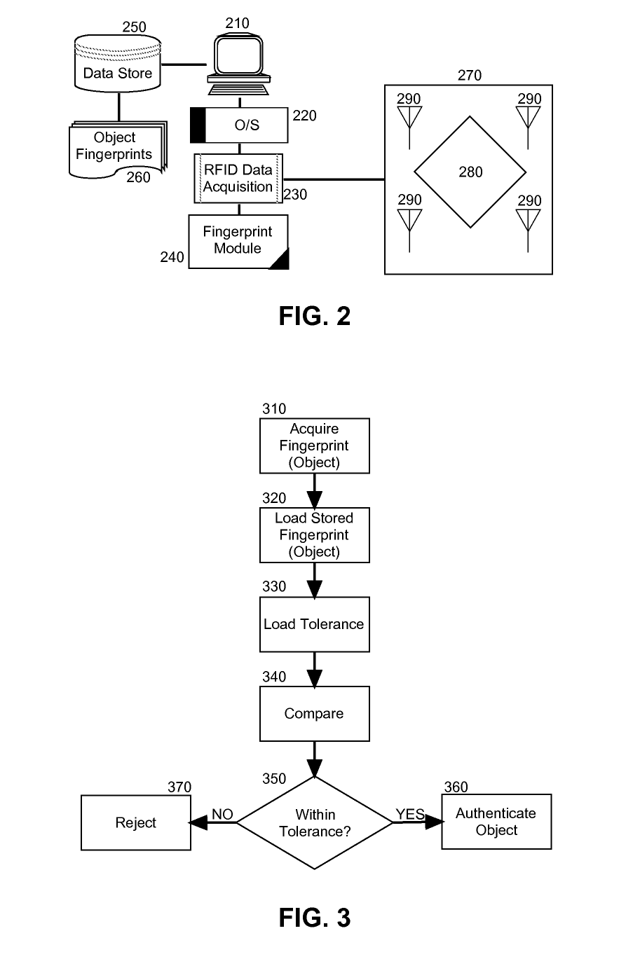

The process described in connection with FIG. 1 can be implemented in an RFID data processing system. In yet further illustration, FIG. 2 is a schematic illustration of an RFID data processing system configured for creating and managing RFID fingerprints to ensure object authenticity. The system can include a host computer 210 with processor and memory supporting the execution of operating system 220. The operating system 220 can host the execution of RFID data acquisition application 230. A data store 250 of object fingerprints 260 also can be coupled to the host computer 210 and configured for access by the RFID data acquisition application 230.

The RFID data acquisition application 230 can be communicatively coupled to one or more RFID readers 290 positioned about a sensing zone 270 into which an object 280 is placed either to create a fingerprint for the object 280, or to authenticate the object 280 against a previously stored fingerprint for the object 280. Notably, fingerprint module 240 can be coupled to the RFID data acquisition application 230. The fingerprint module 240 can include computer program instructions which when executed in memory by the processor of the host computer 210 can acquire a sensed signal from each of the RFID readers 290 through the RFID data acquisition application 230. The sensed signal can include voltage levels for RFID tags (not shown) affixed to the object 280 and also an identification of each of the RFID tags.

The computer program instructions of the fingerprint module 240 further can be enabled during execution to generate a fingerprint for the object 280 by encoding the sensed signal into a value or a set of values. For instance, a set of values can be produced to include for each RFID tags, a unique identifier of the RFID tag, a modulated direct current voltage of the RFID tag, and a maximum fluctuation of direct current voltage for the RFID tag. Optionally, the computer program instructions of the fingerprint module 240 can be enabled during execution to encrypt the fingerprint. Finally, the computer program instructions of the fingerprint module 240 can be enabled during execution by the processor of the host computer 210 to compare the fingerprint to a previously stored one of the object fingerprints 260 in the data store 250 to determine whether or not the object 280 is authentic.

In even yet further illustration of the operation of the fingerprint module 240 in authenticating an object, FIG. 3 is a flow chart illustrating a process for managing RFID fingerprints to ensure object authenticity. Beginning in block 310, a current fingerprint can be acquired for an authenticating object within a sensing zone. The current fingerprint can include, for example, a set of values including voltage levels for each RFID sensor affixed to the authenticating object, as well as a number of tags affixed to the object, an identification of each RFID tag, and a maximum fluctuation of direct current voltage read for each tag. In block 320, a stored fingerprint for the authenticating object can be retrieved from fixed storage and a tolerance for comparison error can be loaded as well indicating a permissive deviation between two fingerprints being compared in order to declare matching fingerprints.

In block 340, the stored fingerprint can be compared to the current fingerprint. For example, the voltage reading for each RFID tag of a unique identifier in the stored fingerprint can be compared to the voltage reading for each corresponding RFID tag of the same unique identifier in the current fingerprint. In decision block 350, to the extent that each compared voltage reading is within the loaded tolerance, a match can be determined for that RFID tag. If all RFID tags are determined to match, then the current fingerprint can be determined to match the stored fingerprint and the authenticating object can be authenticated in block 360. Otherwise, the authenticating object can be determined to be unauthentic in block 370.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An object fingerprint creation method comprising:
receiving a sensed signal from at least one radio frequency identification (RFID) reader resulting from at least one RFID tag affixed to a target object;
extracting a voltage produced by the RFID tag from the sensed signal; and,
storing the voltage as a fingerprint for the target object for later comparison with another fingerprint for an authenticating object to determine whether or not the authenticating object is the target object.

2. The method of claim 1, wherein storing the voltage as a fingerprint for the target object, comprises:
additionally extracting a unique identifier produced by the RFID tag from the sensed signal;
associating the unique identifier with the voltage;
encoding the unique identifier and voltage into a value; and,
storing the value as the fingerprint for the target object.

3. The method of claim 1, further comprising encrypting the fingerprint prior to storing the fingerprint.

4. The method of claim 1, further comprising:
generating a current fingerprint for an authenticating object, the current fingerprint comprising at least one voltage extracted from a sensed signal from an RFID reader for a corresponding RFID tag affixed to the authenticating object;
comparing the current fingerprint to the stored fingerprint;
computing whether the compared current fingerprint and stored fingerprint differ by less than a threshold value; and,
determining the authenticating object to be authentic responsive to the current fingerprint and stored fingerprint differing by less than the threshold value, but otherwise determining the authenticating object to be unauthentic.

5. An object authenticating data processing system comprising:
a host computer comprising a processor, memory, and an operating system executing therein;
a radio frequency identification (RFID) data acquisition application hosted by the operating system and coupled to a plurality of RFID readers positioned to define a sensing zone;
a data store of stored fingerprints each corresponding to a different target object; and,
a fingerprint module coupled to the RFID data acquisition application and configured for execution in the memory of the host computer by the processor of the host computer, the module comprising computer program instructions which when executed by the processor receive a sensed signal from the RFID data acquisition application for the RFID readers resulting from a plurality of RFID tags affixed to an authenticating object disposed in the sensing zone, extract a voltage produced by each of the RFID tags from the sensed signal, arrange each extracted voltage into a current fingerprint, and compare the current fingerprint with another fingerprint for an already processed object to determine whether or not the authenticating object is the already processed object.

6. The system of claim 5, wherein the RFID tags are positioned at different angles on at least one surface of the authenticating object.

7. The system of claim 5, wherein the stored fingerprints are encrypted.

8. The system of claim 5, wherein the stored fingerprints comprises a set of values, each value comprising a unique identifier of an RFID tag, a modulated direct current voltage of the RFID tag corresponding to the unique identifier and a maximum fluctuation of the direct current voltage for the RFID tag corresponding to the unique identifier.

9. A computer program product comprising a computer usable medium embodying computer usable program code for object fingerprint creation, the computer program product comprising:
computer usable program code for receiving a sensed signal from at least one radio frequency identification (RFID) reader resulting from at least one RFID tag affixed to a target object;
computer usable program code for extracting a voltage produced by the RFID tag from the sensed signal; and,
computer usable program code for storing the voltage as a fingerprint for the target object for later comparison with another fingerprint for an authenticating object to determine whether or not the authenticating object is the target object.

10. The computer program product of claim 9, wherein the computer usable program code for storing the voltage as a fingerprint for the target object, comprises:
computer usable program code for additionally extracting a unique identifier produced by the RFID tag from the sensed signal;
computer usable program code for associating the unique identifier with the voltage;
computer usable program code for encoding the unique identifier and voltage into a value; and,
computer usable program code for storing the value as the fingerprint for the target object.

11. The computer program product of claim 9, further comprising computer usable program code for encrypting the fingerprint prior to storing the fingerprint.

12. The computer program product of claim 9, further comprising:
computer usable program code for generating a current fingerprint for an authenticating object, the current fingerprint comprising at least one voltage extracted from a sensed signal from an RFID reader for a corresponding RFID tag affixed to the authenticating object;
computer usable program code for comparing the current fingerprint to the stored fingerprint;
computer usable program code for computing whether the compared current fingerprint and stored fingerprint differ by less than a threshold value; and,
computer usable program code for determining the authenticating object to be authentic responsive to the current fingerprint and stored fingerprint differing by less than the threshold value, but otherwise determining the authenticating object to be unauthentic.
